(19) United States
(12) Patent Application Publication
(10) Pub. No.: US 2019/0377660 A1
(43) Pub. Date: Dec. 12, 2019

(54) METHODS AND SYSTEMS FOR BLOCKCHAIN TESTING

(71) Applicant: Blocktest Global, Grand Cayman (KY)

(72) Inventor: Keman Huang, Somerville, MA (US)

(73) Assignee: Blocktest Global, Grand Cayman (KY)

(21) Appl. No.: 16/435,366

(22) Filed: Jun. 7, 2019

Related U.S. Application Data
(60) Provisional application No. 62/681,941, filed on Jun. 7, 2018.
(60) Provisional application No. 62/734,903, filed on Sep. 21, 2018.

(51) Int. Cl. G06F 11/36

(52) U.S. Cl. CPC G06F 11/3612; G06F 11/3692

(57) ABSTRACT

Methods and systems for testing blockchain technology measuring blockchain performance, calculating blockchain performance metrics, and presenting blockchain test results to a user. Considering both network size and workload level, the system automatically identifies potential flaws in a blockchain technology solution, evaluates operational performance criteria, including scalability, scalability robustness, workload, workload robustness, security and privacy.

### CROSS-REFERENCE TO RELATED APPLICATIONS

This application claims priority to U.S. Provisional Application No. 62/681,941, filed on Jun. 7, 2018, entitled “Methods and Systems for Blockchain Testing,” and claims priority to U.S. Provisional Application No. 62/734,903, filed on Sep. 21, 2018, entitled “Methods and Systems for Blockchain Testing,” the contents of which are incorporated herein by reference.

### TECHNICAL FIELD

The present disclosure generally relates to blockchain technology performance testing.

### BACKGROUND OF THE INVENTION

Rigorous and fair evaluations of blockchain technology solutions are urgently needed in the blockchain community.

In June of 2017, Hyperledger announced the creation of a performance and scalability working group to focus on the Hyperledger-based blockchain technology performance assessments. The Hyperledger Performance and Scalability Working Group has identified multiple issues with attempting to test blockchain technology solutions. Its website notes:
There is no formal definitions of the various metrics and how to measure them
   The PSWG is actively working on defining key metrics and then how to measure them.
There is no official project or benchmark that can be fairly be applied across the multiple DLTs.
   Once the PSWG defines the metrics, then a “benchmark” can be developed. There has already been one project proposed (Caliper),
The logistics of how to ensure that any measurements are gathered fairly and provide a “fair and just” result needs to be worked out.
The logistics of how to ensure that all the announced performance numbers can be reproduced.
   This will entail ensuring that ail code, tunings, configurations, etc are published with the results,
      Wiki.hyperledger.org/groups/pswg/performance-and-scale-wg (visited Jun. 7, 2018)

In March of 2018, Hyperledger Caliper was introduced. Caliper is described as “a blockchain performance benchmark framework, which allows users to test different blockchain solutions with predefined use cases, and get a set of performance test results.” Github.com/hyperledger/caliper (visited Jun. 7, 2018)

Earlier in 2017, researchers at the National University of Singapore, along with others, developed a blockchain performance framework called BLOCKBENCH and published an article entitled, “BLOCKBENCH: A Framework for Analyzing Private Blockchains”.

### SUMMARY

In accordance with an embodiment of the invention, a method of testing a blockchain technology solution is provided, including selecting a network size; selecting a workload level; operating said blockchain technology solution using a network of nodes at said network size and with a workload at said workload level; determining one or more of transaction latency scalability, transaction latency scalability robustness, transaction throughput scalability, transaction throughput scalability robustness, transaction fail ratio scalability, transaction fail ratio scalability robustness, CPU consumption scalability, CPU consumption scalability robustness, RAM consumption scalability, RAM consumption scalability robustness, transaction fee scalability, transaction fee scalability robustness of said blockchain technology solution; and graphically displaying a result of the determining step.

In accordance with another embodiment of the invention, a method of testing a blockchain technology solution is provided including selecting a network size; selecting a workload level; operating said blockchain technology solution using a network of nodes at said network size and with a workload at said workload level; determining one or more of transaction latency workload, transaction latency workload robustness, transaction throughput workload, transaction throughput workload robustness, transaction fail ratio workload, transaction fail ratio workload robustness, CPU consumption workload, CPU consumption workload robustness, and RAM consumption workload, and RAM consumption workload robustness of said blockchain technology solution; and graphically displaying a result of the determining step.

3. In accordance with another embodiment of the invention, a method of testing a blockchain technology solution, including selecting a network size; selecting a workload level; operating said blockchain technology solution using a network of nodes at said network size and with a workload at said workload level; determining the blockchain solution's security and privacy level, including information about a set of potential flaws in the blockchain solution, including the number of potential flaws and the severity of each determined potential flaw, and information about the privacy mechanism used in the blockchain solution, including a measurement of the effectiveness of the privacy mechanism, and graphically displaying a result of the determining step.

### BRIEF DESCRIPTION OF THE FIGURES

FIG. 1 provides a system architecture for a blockchain testing system.

FIG. 2 provides a five-axis performance metric for testing blockchain technology.

FIG. 3 is a flowchart of a testing methodology according to an exemplary embodiment of the present invention.

FIG. 4 is flowchart of a transaction performance testing methodology according to an exemplary embodiment of the present invention.

FIG. 5 is flowchart of a resource performance testing methodology according to an exemplary embodiment of the present invention.

FIG. 6 is a flowchart of a scalability robustness testing methodology according to an exemplary embodiment of the present invention.

FIG. 7 is a flowchart of a workload robustness testing methodology according to an exemplary embodiment of the present invention.

FIG. 8 is a flowchart of a composite performance scoring methodology according to an exemplary embodiment of the present invention.

FIGS. 9A, 9B, and 9C are graphs showing sample transaction latency scalability, transaction throughput scalability, and transaction fail ratio scalability displays and corresponding robustness determinations, respectively.

FIGS. 10A, 10B and 10C are graphs showing sample transaction CPU consumption scalability, RAM consumption scalability and transaction fee scalability displays and corresponding robustness determinations, respectively.

FIGS. 11A, 11B, 11C, 11D, 11E and 11F are graphs showing sample transaction latency workload, transaction throughput workload, transaction fail ratio workload, CPU consumption workload, RAM consumption workload and transaction fee workload displays and corresponding robustness determinations, respectively.

FIG. 12A is a graph a showing sample blockchain performance surface display for transaction latency.

FIG. 12B is a sample dashboard display of performance metrics according to another embodiment of the invention.

### DETAILED DESCRIPTION

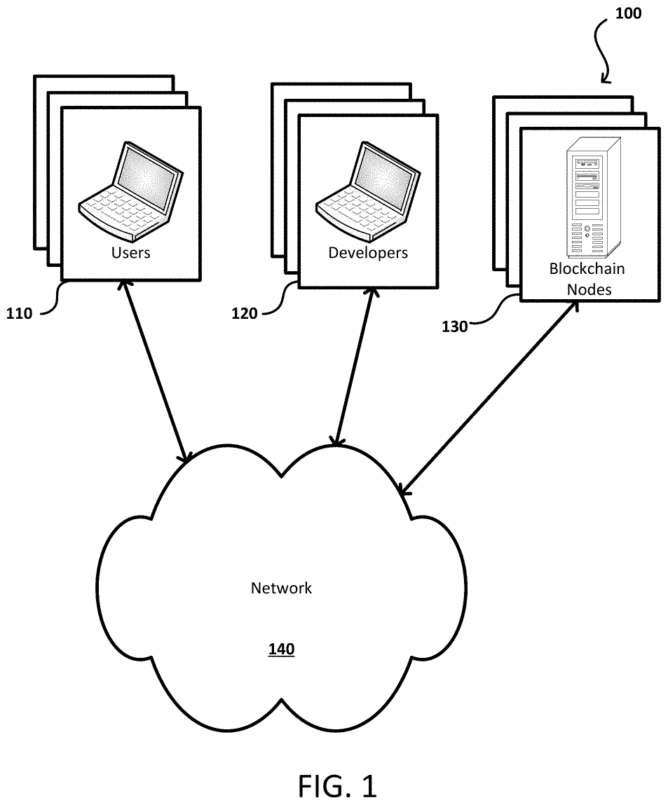

FIG. 1 provides a system architecture 100 for a blockchain testing system. System 100 includes users 110, developers 120, blockchain nodes 130, and network 140. Preferably blockchain nodes 130 comprise computer servers with CPUs, RAM memory storage, and input/output (I/O) hardware, which in some embodiments may be provided by a cloud computing network service like Amazon Web Services (AWS). In some embodiments, network 140 is public network, like the Internet, or a private network like a LAN, WAN, or other wired or wireless communication network. Developers 120 preferably are able to connect to network 140 via conventional terminals, such as a server computer, personal computer, laptop computer, tablet computer, mobile computer or the like, to upload software. Users 110 preferably are able to connect to network 140 via conventional terminals, such as a personal computer, laptop computer, tablet computer, mobile computer or the like, to access and interact with blockchain technology software interfaces.

In a preferred embodiment, developers 120 upload a blockchain technology solution to blockchain nodes 130 via network 140. Nodes 130 implement blockchain testing methodologies to test the performance of the blockchain technology solution. Performance displays are provided by nodes 130 to developers 120 via network 140. Optionally, users 110 may interact with the blockchain technology solution to provide input and receive output.

In an alternate embodiment, not shown, at least one of blockchain nodes 130 is a server node for controlling a set of blockchain nodes 130, distributing test methodologies, collecting test results, and/or providing performance displays to one or more of developers 120 via network 140. Other systems to automatically evaluate blockchain-based solution performance are described in U.S. Provisional Patent Application No. 62/689,713, which is hereby incorporated by reference in its entirety.

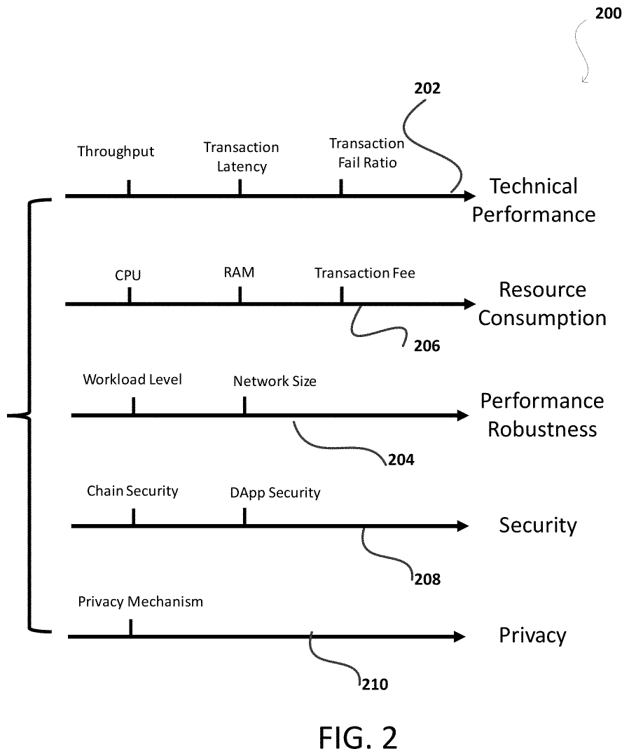

As shown in FIG. 2, to objectively verify the real performance of a given blockchain solution, an exemplary embodiment of the present invention develops a model to evaluate blockchain performance from five different dimensions. FIG. 2 provides a five-axis performance metric 200 for testing blockchain technology. Along axis 202 are technical performance metrics, such as transaction latency, throughput, and transaction fail ratio. Preferably, “technical performance” refers to the value of different technical indicators for a blockchain-based solution. “Transaction Latency” (TL) refers to the time interval between the time when a transaction is submitted and the time when a transaction is confirmed to be committed by the blockchain solution. “Throughput” (TPS) refers to the number of successful transactions per second, also known as “TPS.” “Transaction Fail Ratio” (TFR) refers to the percentage of submitted transactions which are not implemented or otherwise dealt with by the blockchain solution after a prescribed period of time.

Along axis 206 are resource consumption metrics, such as CPU usage, RAM usage and Transaction fee. Preferably, “resource consumption” refers to the hardware, software and economic resource consumptions needed to launch and/or operate over a specified period of time a blockchain solution. “CPU consumption” refers to the percentage of consumed CPU power of the given CPU configuration when the blockchain solution is executed, including the average, maximum (or peak) and minimum consumed CPU power. “RAM consumption” refers to the consumed percentage of random access memory (RAM) of the given RAM configuration when the blockchain solution is executed, including the average, maximum (or peak) and minimum consumed RAM. In some embodiments, RAM consumption may be a quantity in units of information, like bytes, megabytes, gigabytes, or the like. “Transaction fee” refers to the consumed transaction fee when the blockchain solution is executed on the blockchain. The transaction fee may be made up of one or more individual fees if the transaction requires multiple fees, for example to execute sub-transactions.

Along axis 204 are performance robustness metrics, such as workload level and network size. Preferably, “performance robustness” refers to the change in technical performance and resource consumption in relation to different network sizes and workload levels, indicating the blockchain solution's robustness in different network and workload configurations. “Network size” refers to the number of computers nodes used to execute the blockchain solution or, alternatively, the number of processors. “Workload level” refers to the transaction workload for the blockchain solution to process. The transaction workload may be created by users 110 or by simulated workloads.

Along axis 208 are security metrics, such as chain security, and DApp security. Preferably, “security” refers to the security feature for the blockchain solution, representing the security performance of the blockchain solution. “Chain security” refers to the number and severity of the flaws founded in the blockchain. “DApp security” refers to number and severity of the flaws founded in the DApp built on the blockchain. For example, for the DApp built on ETH, this DApp security may include the security level for both the smart contract code, stored on the blockchain, and the frontend, which may be a web application. The security performance of a blockchain solution may be measured by scanning it for known vulnerabilities, identifying any specific security measures that are implemented, or performing a static or dynamic analysis of the solution, as is known are known in the art. See, e.g., Mauro Conti, et. al, A Survey on Security and Privacy Issues of Bitcoin, arXiv:1706.00916v3 (December 2017), available at https://arxiv.org/pdf/1706.00916.pdf, which is hereby incorporated by reference.

Along axis 210 are privacy metrics. Preferable, “Privacy” refers to the privacy level implemented in the blockchain solution, representing the privacy mechanism the blockchain solution used to enhance the privacy level for data used in the solution. The privacy performance of a blockchain solution may be measured by scanning it for known issues and identifying the privacy mechanism used.

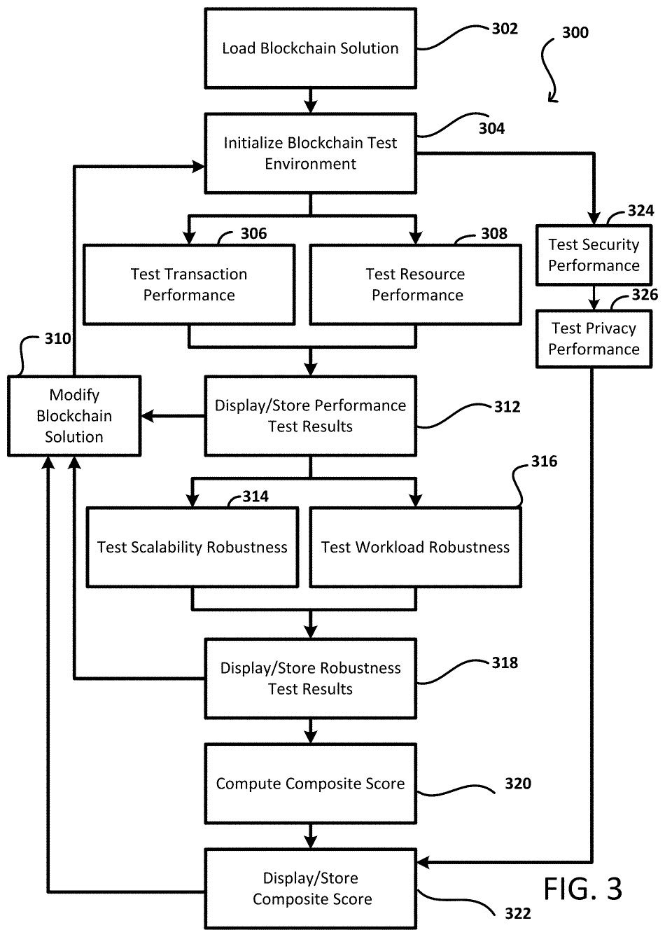

FIG. 3 is a flowchart of a testing methodology 300 according to an exemplary embodiment of the present invention. In step 302, the blockchain solution is loaded into one or more nodes of the system. In step 304, the blockchain environment is initialized using a selected configuration, including the workload level and network size, and blockchain solution is deployed on the given computation environment.

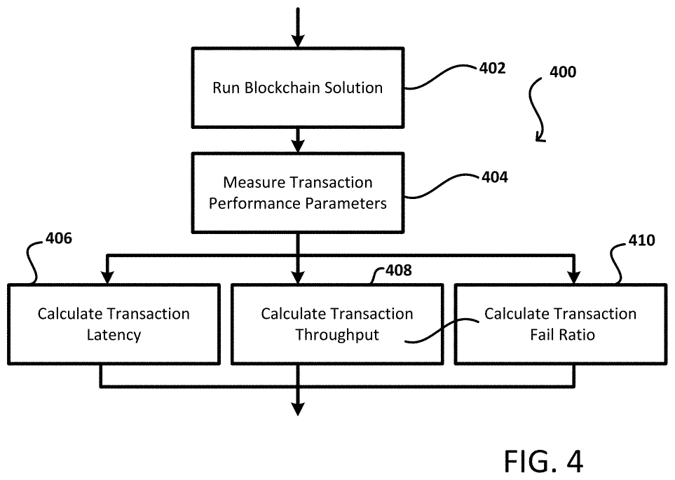

In step 306, transaction performance is tested. This can be done in parallel with resource performance testing in step 308. Alternatively, steps 306 and 308 can be performed in series or in an interleaved series of tests. In step 306, preferably, the technical performance of the solution is tested. For the given network size and workload level, the transaction latency is measured, transaction throughput is measured, and the fail ratio after the blockchain solution is successfully executed is calculated. Further details are shown in and described in connection with FIG. 4.

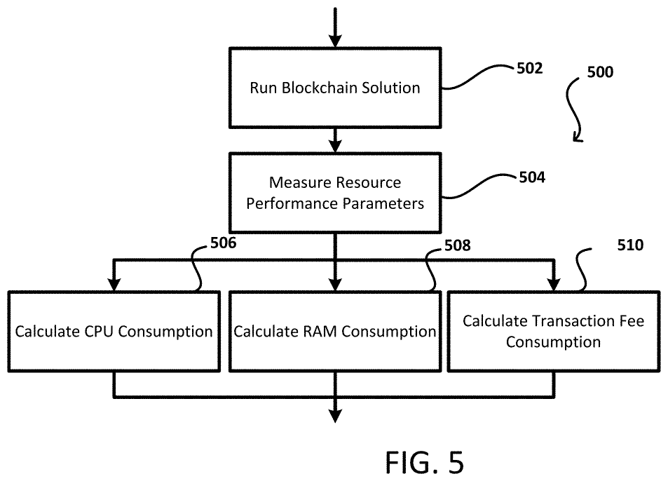

In step 308, transaction performance is tested and preferably blockchain solution resource consumption is measured. For the given network size and workload level, CPU computing power and RAM consumption are measured for nodes operating the deployed blockchain solution. Further details are shown in and described in connection with FIG. 5.

In step 312, the results of step 306 and/or step 308 are displayed and/or stored. Preferably, test results are displayed to developers 120 via a graphic user interface. It is further preferred that raw and/or processed performance data are stored in a database (not shown), such as a blockchain.

Optionally, in step 310, developers 120 may modify the tested blockchain solution to address performance issues and supply the modified blockchain solution to the system for further testing. As a further alternative, the blockchain environment may be modified to change the workload level and/or network size. An iterative testing and modification loop is thereby created. Optionally, steps 310 and/or 312 may be omitted.

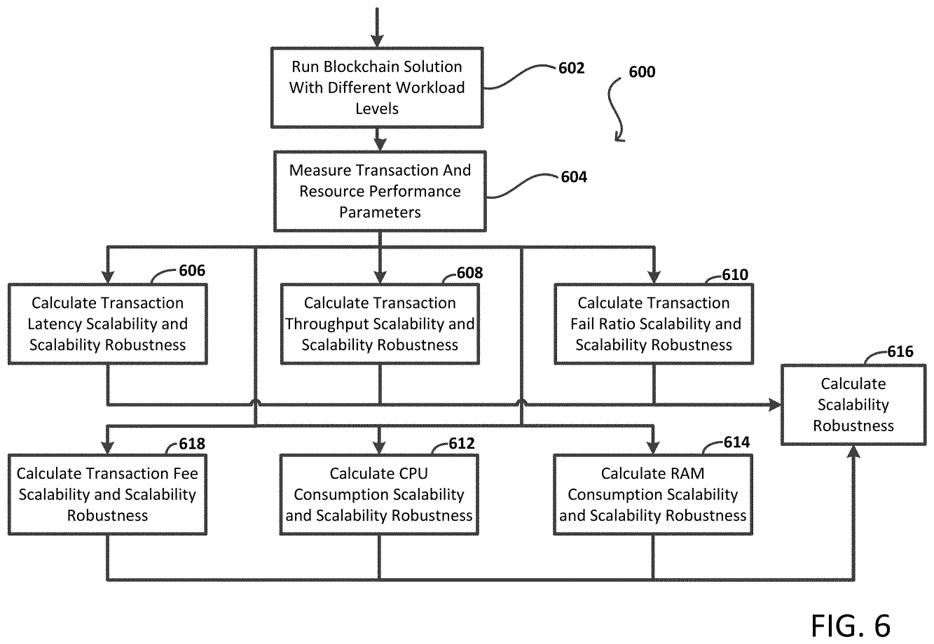

In step 314, scalability robustness is tested. This can be done in parallel with workload robustness testing in step 316. Alternatively, steps 314 and 316 can be performed in series or in an interleaved series of tests. In step 314, preferably, the testing environment repeats the performance tests using different workload levels and collects the results of each test. One or more of transaction latency scalability, transaction latency scalability robustness, transaction throughput scalability, transaction throughput scalability robustness, transaction fail ratio scalability, transaction fail ratio scalability robustness, CPU consumption scalability, CPU consumption scalability robustness, RAM consumption scalability, and RAM consumption scalability robustness, transaction fee scalability and transaction fee scalability robustness are measured and/or calculated. Further details are shown in and described in connection with FIG. 6.

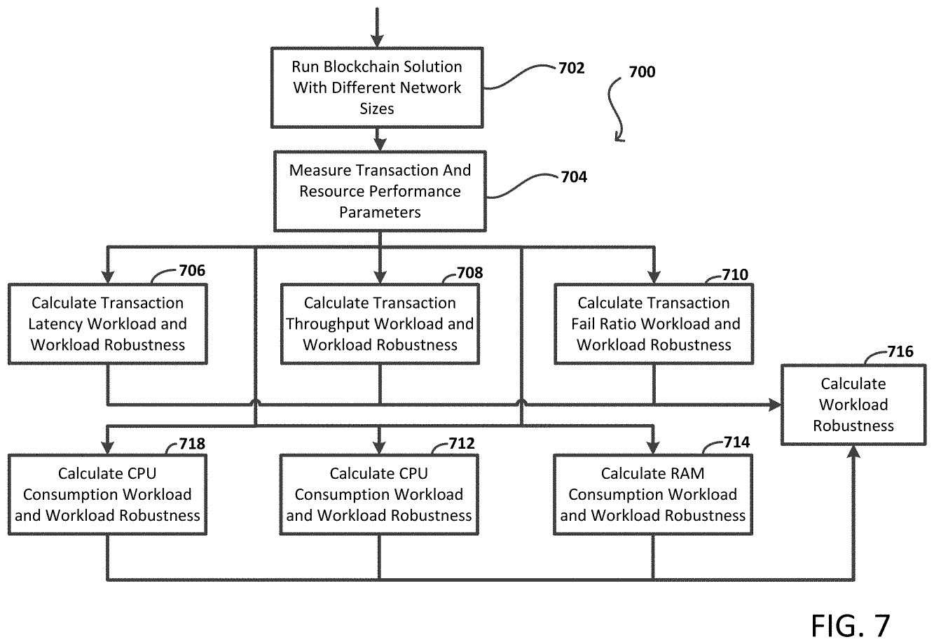

In step 316, workload robustness is tested. In step 316, preferably, the testing environment repeats the performance tests using different network sizes and collects the results of each test. One or more of transaction latency workload, transaction latency workload robustness, transaction throughput workload, transaction throughput workload robustness, transaction fail ratio workload, transaction fail ratio workload robustness, CPU consumption workload, CPU consumption workload robustness, RAM consumption workload, RAM consumption workload robustness, transaction fee workload and transaction fee workload robustness are measured and/or calculated. Further details are shown in and described in connection with FIG. 7.

In step 318, the results of step 314 and/or step 316 are displayed and/or stored. Preferably, test results are displayed to developers 120 via a graphic user interface. It is further preferred that raw and/or processed performance data are stored in a database (not shown), such as a blockchain. Optionally, in step 310, developers 120 may modify the tested blockchain solution to address performance issues and supply the modified blockchain solution to the system for further testing. As a further alternative, the blockchain environment may be modified to change the workload level and/or network size. An iterative testing and modification loop is thereby created. Optionally, steps 310 and/or 318 may be omitted.

In step 324, the security and privacy performance of the blockchain solution is tested to detect potential software flaws at the chain level, and to detect flaws in the the other components of the solution, such as those occurring at the DApp level (including in some embodiments, for example, flaws in the web interface frontend to the DApp). The system determines the number and severity of the discovered flaws. At step 326, an analysis is performed on the privacy mechanism used by the solution, including, preferably, those mechanisms that are part of the blockchain implementation, those that are part of the smart contract or blockchain code, and those that are part of any frontend or web interface for a DApp, if such exists in the solution. The system then preferably determines the number and severity of any discovered flaws in the privacy mechanism, or evaluates the robustness of the privacy mechanism in a qualitative or quantitative way.

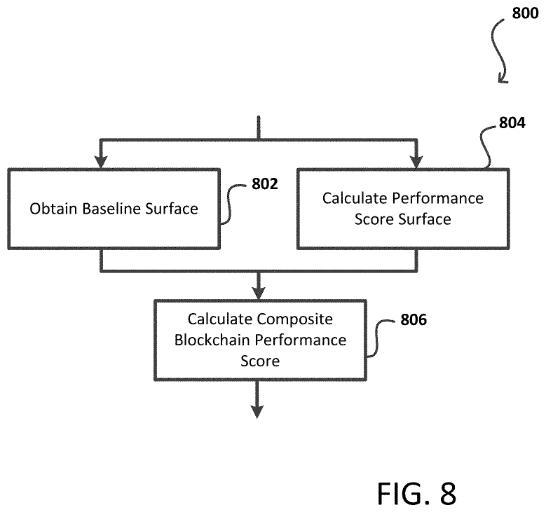

In step 320, a composite blockchain performance score is calculated. Data collected during the foregoing steps are compiled and utilized to calculate a composite performance score. For example, a weighted score adding together each performance measurement multiplied by a weighting factor may be calculated. Further details are shown in and described in connection with FIG. 8.

In step 322, the results of step 320 are displayed and/or stored. Preferably, test results are displayed to developers 120 via a graphic user interface. It is further preferred that raw and/or processed performance data are stored in a database (not shown), such as a blockchain. Optionally, in step 310, developers 120 may modify the tested blockchain solution to address performance issues and supply the modified blockchain solution to the system for further testing. As a further alternative, the blockchain environment may be modified to change the workload level and/or network size. An iterative testing and modification loop is thereby created. Optionally, steps 310 and/or 320 may be omitted.

FIG. 4 is flowchart of a transaction performance testing methodology 400 according to an exemplary embodiment of the present invention. It is an exemplary embodiment of transaction performance testing 306 from FIG. 3. In step 402, the blockchain solution is run using a configuration of the blockchain testing environment. In step 404, transaction performance data for each transaction generated by users (actual or simulated) and submitted to the blockchain solution is measured and/or collected, including, for example, when the transaction is submitted to the system t_{i,s} and when the transaction is confirmed by the blockchain solution t_{i,h}.

In step 406, after a predetermined execution duration, for each committed transaction, the transaction latency is calculated as t_{i,h}−t_{i,s}. The transaction latency data for each transaction can be aggregated into one aggregate transaction latency. One typical aggregation method is to calculate their average value as

$$\frac{1}{w} {\sum }_{( i = 1 )}^{w} {t}_{i , h} - {t}_{i , s} .$$

Here “w” refers to the number of committed transactions. In step 408, after the predetermined execution duration, for each transaction which is committed by the blockchain solution, calculate the transaction throughput as

$$\frac{w}{{\sum }_{( i = 1 )}^{w} {t}_{i , h} - {t}_{i , s}} .$$

In step 410, after the predetermined execution duration, for those submitted but not committed transactions, calculate the transaction fail ratio as:

$$\frac{f}{( w + f )}$$

where “f” refers to the number of uncommitted transactions. Steps 406, 408, and 410 may be performed in parallel, in series, or in an interleaved manner.

FIG. 5 is flowchart of a resource performance testing methodology 500 according to an exemplary embodiment of the present invention. It is an exemplary embodiment of resource performing testing 308 from FIG. 3. In step 502, the blockchain solution is run using a configuration of the blockchain testing environment. In step 504, during execution of the blockchain solution, measure and/or collect CPU consumption and RAM consumption data for each computer node in the network, or optionally, a subset of the nodes.

In step 506, after the predetermined execution duration, for each node, the CPU consumption is calculated, which can be the maximum (or peak) CPU consumption, or the average CPU consumption over time. An aggregate CPU consumption can be calculated for each node, for a subset of nodes, or for the entire network of nodes. For example, the aggregation can be the average function. Alternatively, the aggregation can be an identification of the peak CPU consumption among all the nodes in the network.

In step 508, after a predetermined execution duration, for each node, its RAM consumption is calculated, which can be the maximum (or peak) RAM consumption, or the average RAM consumption over time. An aggregate RAM consumption can be calculated for each node, for a subset of nodes, or for the entire network of nodes. For example, the aggregation can be the average function. Alternatively, the aggregation can be an identification of the peak RAM consumption among all the nodes in the network.

In step 510, after a predetermined execution duration, the transaction fee consumption is calculated for the blockchain solution over the execution. The transaction fee may be made up of one or more individual fees if the transaction requires multiple fees, for example to execute sub-transactions. It can also be the maximum (or peak) transaction fee consumption, the average transaction fee consumption or the sum of the transaction fee for all the related transactions.

FIG. 6 is a flowchart of a scalability robustness testing methodology 600 according to an exemplary embodiment of the present invention. It is an exemplary embodiment of scalability robustness testing 314 from FIG. 3. In step 602, the blockchain solution is run using a configuration of the blockchain testing environment. In step 604, during execution of the blockchain solution, transaction performance and/or resource consumption data is measured and/or collected for each computer node in the network, or optionally, a subset of the nodes. Alternatively, step 602 may be omitted and in step 604 transaction performance and/or resource consumption data that has been stored is obtained.

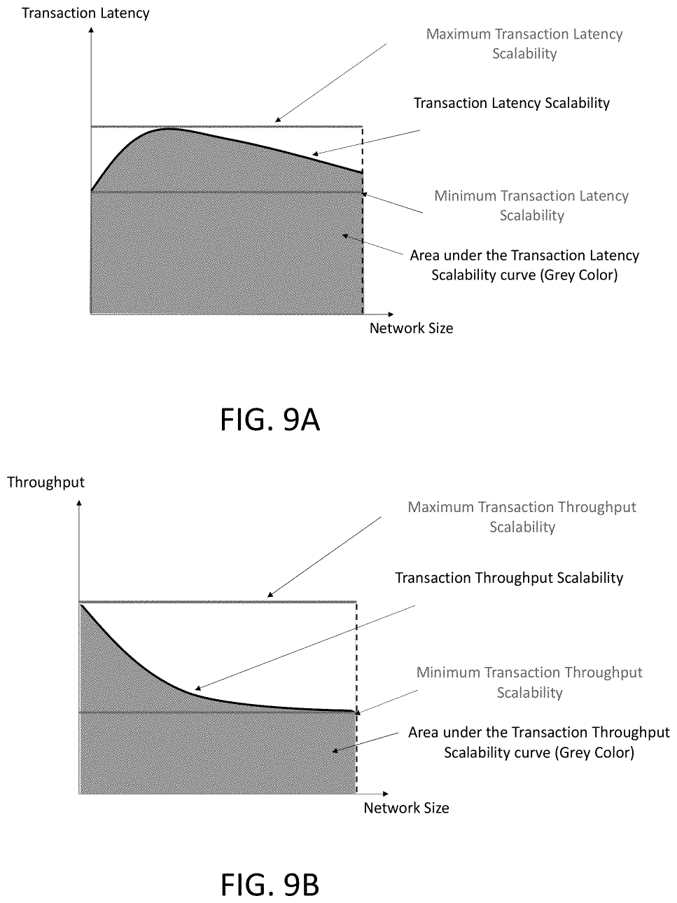

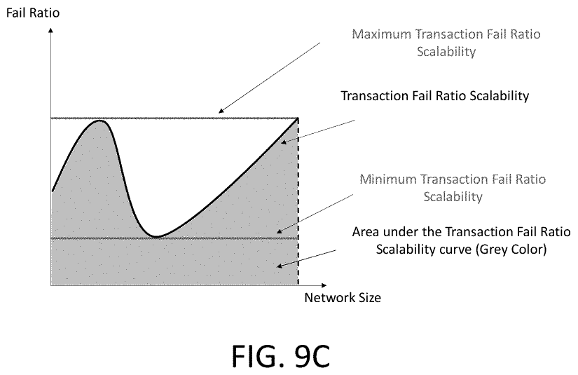

In step 606, for performance data obtained at a particular workload level, as illustrated in FIG. 9A, the transaction latency scalability curve is calculated, representing the latency variations depending on the different network sizes. Preferably, a baseline transaction latency scalability curve (or value) is identified. The baseline transaction latency curve can be the peak latency scalability curve, the minimum latency scalability curve, or another predefined latency scalability curve (or value). The transaction latency scalability robustness (SR(TL)) can be calculated as:

$$SR ( TL ) = \frac{Area under the Transaction Latency Scalability Curve}{ \begin{matrix}Area under the Baseline Transaction Latency \\ Scalability Curve\end{matrix} }$$

In step 608, for performance data obtained at a particular workload level, as illustrated in FIG. 9B, the transaction throughput scalability curve is calculated, representing the throughput variations depending on the different network sizes. Preferably, a baseline transaction throughput scalability curve (or value) is identified. The baseline transaction throughput scalability curve (or value) can be the peak throughput scalability curve, the minimum throughput scalability curve, or another predefined throughput scalability curve (or value). The transaction throughput scalability robustness (SR(TPS)) can be calculated as:

$$SR ( TPS ) = \frac{Area under the Transaction Throughput Scalability Curve}{ \begin{matrix}Area under the Baseine Transaction Throughput \\ Scalability Curve\end{matrix} }$$

In step 610, for performance data obtained at a particular workload level, as illustrated in FIG. 9C, the transaction fail ratio scalability curve is calculated, representing the fail ratio variations depending on the different network sizes. Preferably, a baseline transaction fail ratio scalability curve (or value) is identified. The baseline transaction fail ratio scalability curve can be the peak fail ratio scalability curve, the minimum fail ratio scalability curve, or another predefined transaction fail ratio scalability curve (or value). The transaction fail ratio scalability robustness (SR(TFR)) can be calculated as:

$$SR ( TFR ) = \frac{Area under the Transaction Fail Ratio Scalability Curve}{ \begin{matrix}Area under the Baseline Transaction Fail Ratio \\ Scalability Curve\end{matrix} }$$

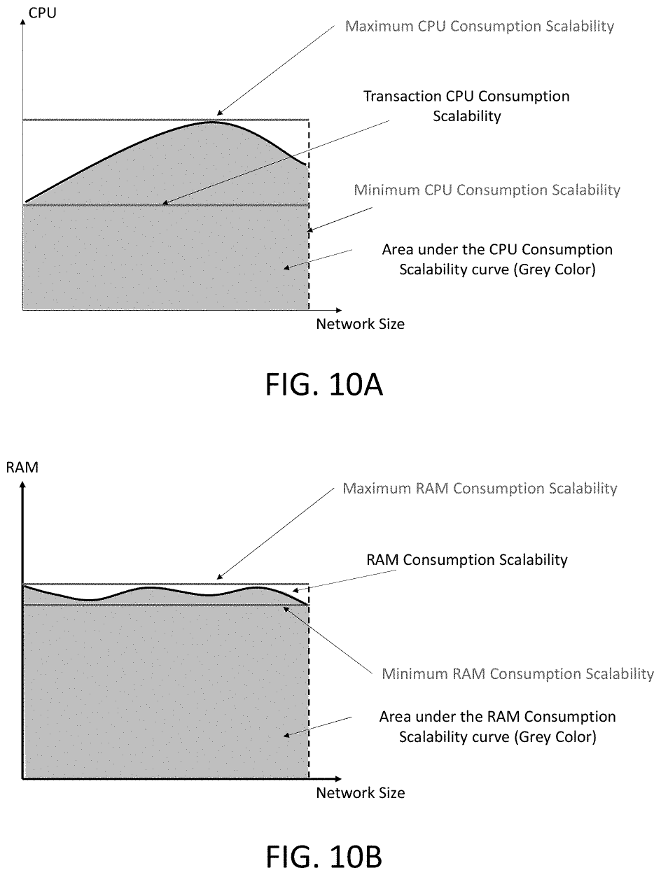

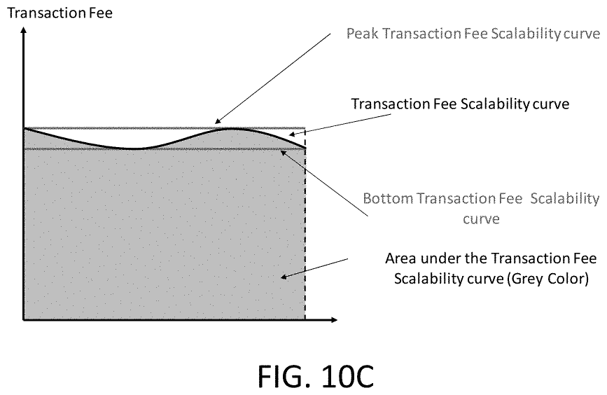

In step 612, for performance data obtained at a particular workload level, as illustrated in FIG. 10A, the CPU consumption scalability curve is calculated, representing the CPU consumption variations depending on the different network sizes. Preferably, a baseline CPU consumption scalability curve (or value) is identified. The baseline CPU consumption scalability curve can be the peak CPU consumption scalability curve, the minimum CPU consumption scalability curve, or another predefined CPU consumption scalability curve (or value). The CPU consumption scalability robustness (SR(CPU)) can be calculated as:

$$SR ( CPU ) = \frac{Area under the CPU Consumption Scalability Curve}{ \begin{matrix}Area under the Baseline CPU Consumption \\ Scalability Curve\end{matrix} }$$

In step 614, for performance data obtained at a particular workload level, as illustrated in FIG. 10B, the RAM consumption scalability curve is calculated, representing the RAM consumption variations depending on the different network sizes. Preferably, a baseline RAM consumption scalability curve (or value) is identified. The baseline RAM consumption scalability curve can be the peak RAM consumption scalability curve, the minimum RAM consumption scalability curve, or another predefined RAM consumption scalability curve (or value). The RAM consumption scalability robustness (SR(RAM)) can be calculated as:

$$SR ( RAM ) = \frac{Area under the RAM Consumption Scalability Curve}{ \begin{matrix}Area under the Baseline RAM Consumption \\ Scalability Curve\end{matrix} }$$

In step 618, for performance data obtained at a particular workload level, as illustrated in FIG. 10C, the transaction fee scalability curve is calculated representing the transaction fee variations depending on the different network sizes. Preferably, a baseline transaction fee scalability curve (or value) is identified. The baseline transaction fee scalability curve can be the peak transaction fee scalability curve, the minimum transaction fee scalability curve, or another predefined transaction fee scalability curve (or value). The transaction fee scalability robustness (SR(TF)) can be calculated as:

$$SR ( TF ) = \frac{Area under the Transaction Fee Scalability Curve}{ \begin{matrix}Area under the Baseline Transaction Fee \\ Scalability Curve\end{matrix} }$$

In step 616, aggregate the five sub-metrics for the scalability robustness. One example of aggregation is as follow:

SR=w₁×SR(TL)+w₂×SR(TPS)+w₃×SR(TFR)+w₄×SR(CPU)+w₅×SR(RAM)+w₆×SR(TF)

Where wᵢ, i=1 . . . 6, Σᵢ wᵢ=1, refers to the weight of these six scalability robustness sub-metrics. If the weight for a sub-metric is set as 0, then that metric is not considered.

FIG. 7 is a flowchart of a workload robustness testing methodology 700 according to an exemplary embodiment of the present invention. It is an exemplary embodiment of scalability robustness testing 316 from FIG. 3. In step 702, the blockchain solution is run using a configuration of the blockchain testing environment. In step 704, during execution of the blockchain solution, transaction performance and/or resource consumption data is measured and/or collected for each computer node in the network, or optionally, a subset of the nodes. Alternatively, step 702 may be omitted and in step 704 transaction performance and/or resource consumption data that has been stored is obtained.

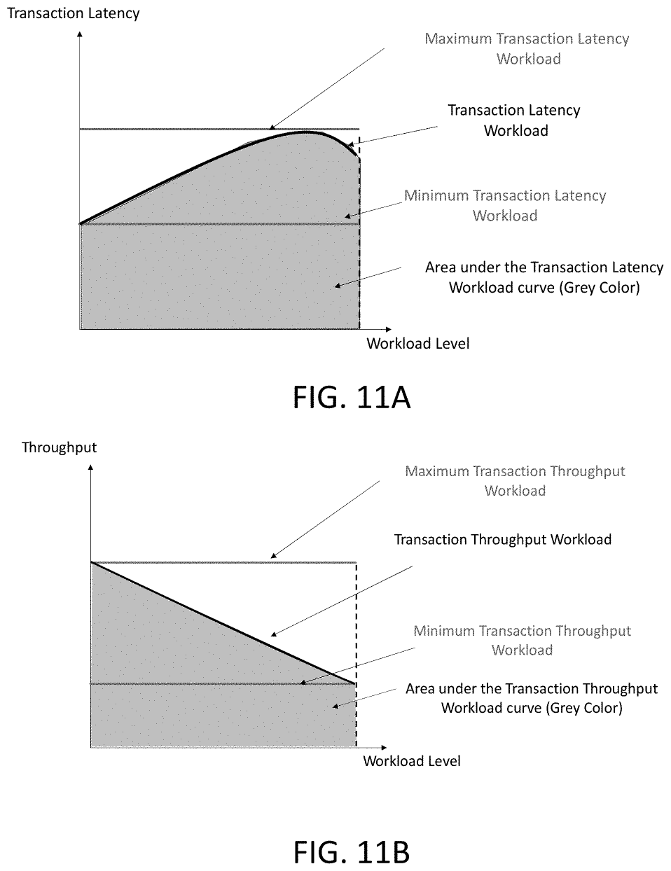

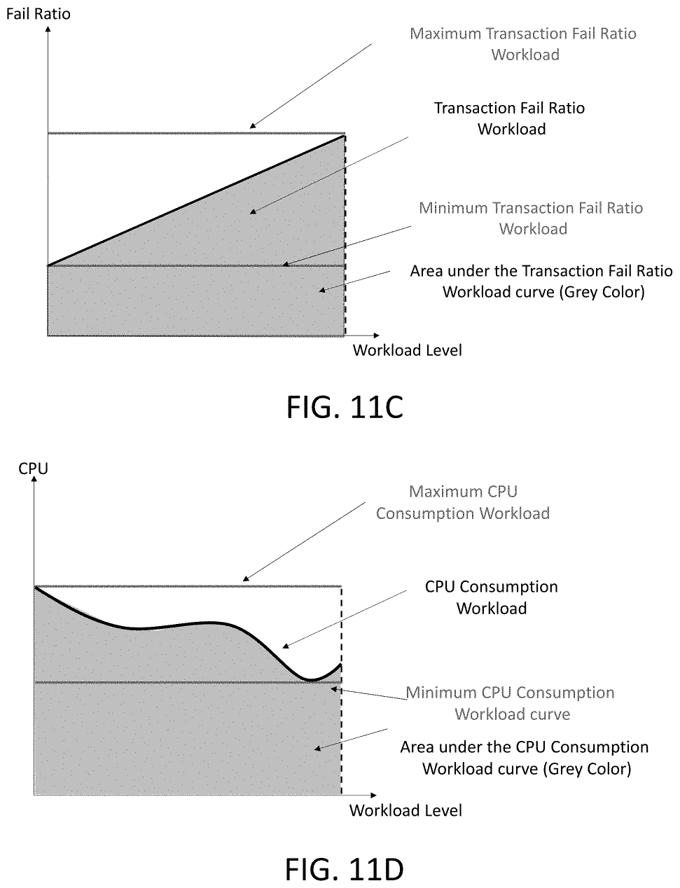

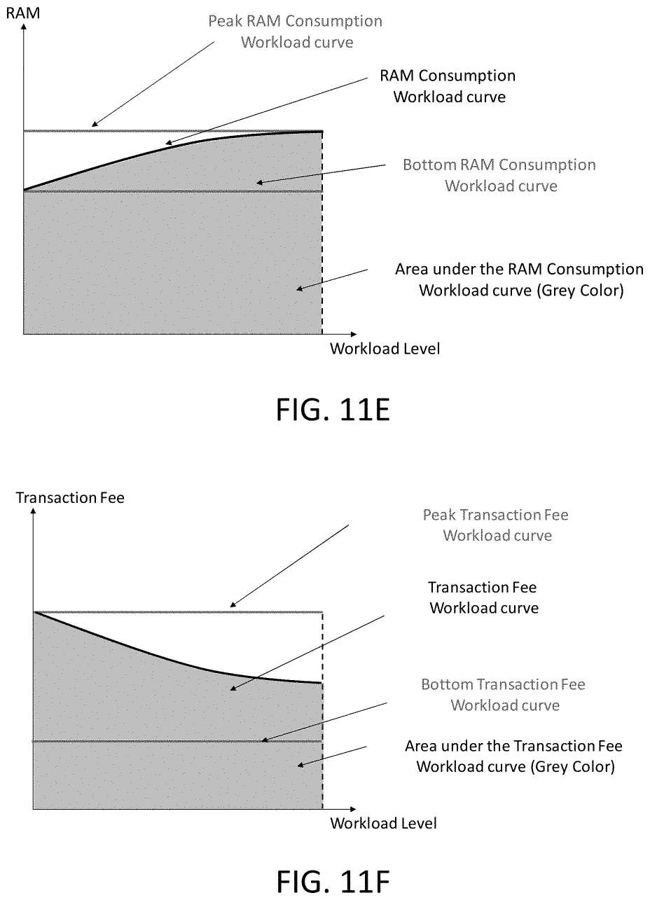

In step 706, as illustrated in FIG. 11A, for performance data obtained at a particular network size, the transaction latency workload curve is calculated, representing the latency variations depending on the different workload levels. Preferably, a baseline transaction latency workload curve (or value) is identified. The baseline transaction latency workload curve may be the peak latency workload curve, the minimum latency workload curve, or another predefined latency workload curve (or value). The transaction latency workload robustness (WL(TL)) can be calculated as:

$$WL ( TL ) = \frac{Area under the Transaction Latency Workload Curve}{ \begin{matrix}Area under the Baseline Transaction Latency \\ Workload Curve\end{matrix} }$$

In step 708, as illustrated in FIG. 11B, for performance data obtained at a particular network size, the transaction throughput workload curve is calculated, representing the throughput variations depending on the different workload levels. Preferably, a baseline transaction throughput workload curve (or value) is identified. The baseline transaction throughput workload curve can be the peak throughput workload curve, the minimum throughput workload curve, or another predefined throughput workload curve (or value). The transaction throughput workload robustness (WL (TPS)) can be calculated as:

$$WL ( TPS ) = \frac{Area under the Transaction Throughput Workload Curve}{ \begin{matrix}Area under the Baseline Transaction Throughput \\ Workload Curve\end{matrix} }$$

In step 710, as illustrated in FIG. 11C, for performance data obtained at a particular network size, the transaction fail ratio workload curve is calculated, representing the fail ratio variations depending on the different workload levels. Preferably, a baseline transaction fail ratio workload curve (or value) is identified. The baseline transaction fail ratio workload curve can be the peak fail ratio workload curve, the minimum fail ratio workload curve, or another predefined transaction fail ratio workload curve (or value). The transaction fail ratio workload robustness (WL(TFR)) can be calculated as:

$$WL ( TFR ) = \frac{Area under the Transaction Fail Ratio Workload Curve}{ \begin{matrix}Area under the Baseline Transaction Fail Ratio \\ Workload Curve\end{matrix} }$$

In step 712, as illustrated in FIG. 11D, for performance data obtained at a particular network size, the CPU consumption workload curve is calculated, representing the CPU consumption variations depending on the different workload levels. Preferably, a baseline CPU consumption workload curve (or value) is identified. The baseline CPU consumption workload curve can be the peak CPU consumption workload curve, the minimum CPU consumption workload curve, or another predefined CPU consumption workload curve (or value). The CPU consumption workload robustness (WL (CPU)) can be calculated as:

$$WL ( CPU ) = \frac{Area under the CPU Consumption Workload Curve}{ \begin{matrix}Area under the Baseline CPU Consumption \\ Workload Curve\end{matrix} }$$

In step 714, as illustrated in FIG. 11E, for performance data obtained at a particular network size, the RAM consumption workload curve is calculated, representing the RAM consumption variations depending on the different workload levels. Preferably, identify a baseline RAM consumption workload curve (or value). The baseline RAM consumption workload curve can be the peak RAM consumption workload curve, the minimum RAM consumption workload curve, or another predefined RAM consumption workload curve (or value). The RAM consumption workload robustness (WL (RAM)) can be calculated as:

$$WL ( RAM ) = \frac{Area under the RAM Consumption Workload Curve}{ \begin{matrix}Area under the Baseline RAM Consumption \\ Workload Curve\end{matrix} }$$

In step 718, as illustrated in FIG. 11F, for performance data obtained at a particular network size, the transaction fee workload curve is calculated, representing the transaction fee variations depending on the different workload levels. Preferably, identify a baseline transaction fee workload curve (or value). The baseline transaction fee workload curve can be the peak transaction fee workload curve, the minimum transaction fee workload curve, or another predefined transaction fee workload curve (or value). The transaction fee workload robustness (WL (TF)) can be calculated as:

$$WL ( TF ) = \frac{Area under the Transaction Fee Workload Curve}{ \begin{matrix}Area under the Baseline Transaction Fee \\ Workload Curve\end{matrix} }$$

In step 716, aggregate the six sub-metrics for workload robustness. For example, the workload robustness can be defined as: WL=w₁×WL(TL)+w₂×WL(TPS)+w₃×WL(TFR)+w₄×WL(CPU)+w₅×WL(RAM)+w₆×WL(TF)

Where wᵢ, i=1 . . . 6, Σᵢ wᵢ=1, refers to the weight of these six workload robustness sub-metrics. If the weight for a sub-metric is set as 0, then that metric is not considered.

FIG. 8 is a flowchart of a composite performance scoring methodology 800 according to an exemplary embodiment of the present invention. It is an exemplary embodiment of scalability robustness testing 320 from FIG. 3. Using the three dimensions model and the methodologies to calculate different metrics described above, a method to aggregate the performance data to calculate a performance score for the given blockchain solution is provided.

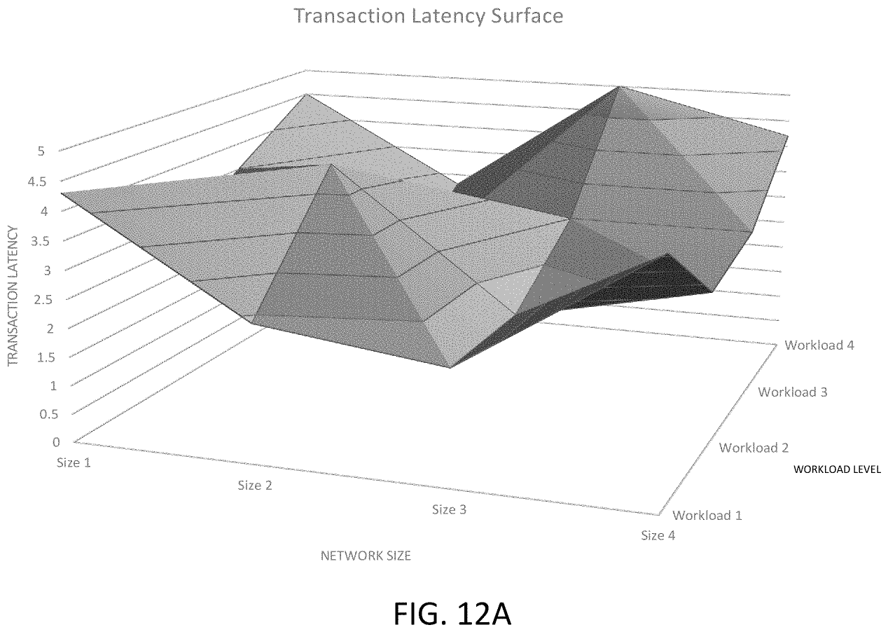

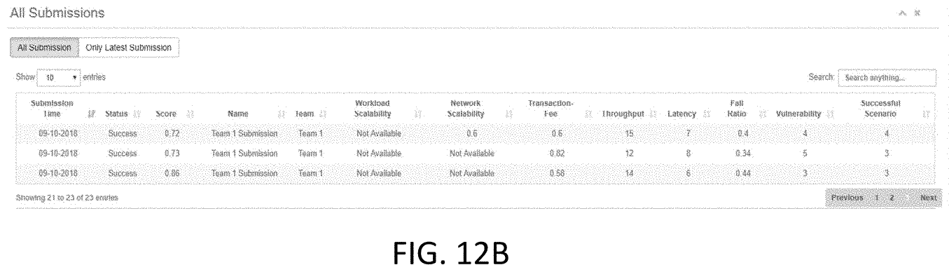

Utilizing the solution performance data, including the technical performance and the resource consumption data, in step 802 a 3-dimensional performance score surface is created. As shown in FIG. 12A, and using the transaction latency (TL) as an example, given different workload levels and network sizes, a 3-D performance score surface for transaction latency is calculated and preferably displayed in a 3-D graphical representation. The volume under the surface is also calculated. The same methodology is used to calculate and graphically display a 3-D performance score surface for each of throughput (TPS), fail ratio (TFR), CPU consumption, RAM consumption and transaction fee (TF), and calculate the respective volume under each performance score surface.

In step 804, again using the transaction latency (TL) as an example, a baseline surface is identified. Preferably, the baseline surface can be the absolute peak, a local maximum, an absolute minimum, or a local minimum, or another defined baseline surface. The volume under the baseline surface is calculated. The same methodology is used to identify a baseline performance score surface for each of throughput (TPS), fail ratio (TFR), CPU consumption, RAM consumption and transaction fee (TF), and calculate the respective volume under each baseline performance score surface.

In step 806, the blockchain performance score for each metric is computed as:

$$Score = {\sum }_{i = 1}^{5} {w}_{i} \times \frac{space under score surface ( {I}_{i} )}{space under baseline score surface ( {I}_{i} )} , \\ I = \{ TL , TPS , TFR , CPU , RAM , TF \}$$

To compare the performances of different blockchain solutions, a dashboard display is provided to effectively visualize and compare the performance of different blockchain solutions, as shown in FIG. 12B.

The various implementations above are applicable in a many different and varied operating environments, on one more electronic devices that incorporate integrated circuits, chips for processing and memory purposes. The proper configuration of hardware, software, and/or firmware is presently disclosed above to improve a computer's ability to interface with currency data. A system or method of the present disclosure also includes a number of the above exemplary systems working together to perform the same function disclosed herein.

Most of the exemplary implementations above utilize at least one communications network using one or more commercial protocols, such as TCP/IP, FTP, UPnP, NFS, and CIFS. The networks 306 can be wireless or wired—including a local area network (LAN), a wide-area network (WAN), a virtual private network, the internet, an intranet, an extranet, a public switched telephone network, an infrared network, a wireless network and one or more of the above networks in a combination.

The present disclosure includes at least a database formed from a variety of data stores and other memory or storage media. These components can reside in one or more of the nodes or servers, as discussed above, or may reside in a network of the servers. In certain embodiments, the information may reside in a storage-area network (SAN). Similarly, files for performing the functions attributed to the computers, servers or other network devices may be stored locally and/or remotely, as appropriate. The computing system of the present disclosure, including the client devices, incorporate hardware elements that are electrically coupled via data/control/and power buses. For example, the one or more processors may be central processing units (CPU) for one or more of the client devices. The client devices may further include at least one input device (e.g., a mouse, keyboard, controller, keypad, or touch-sensitive display) and at least one output device (e.g., a display, a printer or a speaker). Such client devices may also include one or more storage devices, including disk drives, optical storage devices and solid-state storage devices such as random access memory (RAM) or read-only memory (ROM), as well as removable media devices, memory cards, flash cards, etc.

The devices in the present disclosure can also include computer-readable storage media reader, communications devices (e.g., modems, network cards (wireless or wired), or infrared communication devices) and memory, as previously described. The computer-readable storage media reader is connectable or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method of testing a blockchain technology solution, comprising the steps of:
selecting a network size;
selecting a workload level;
operating said blockchain technology solution using a network of nodes at said network size and with a workload at said workload level; and
automatically determining at least one of transaction latency scalability, transaction latency scalability robustness, transaction throughput scalability, transaction throughput scalability robustness, transaction fail ratio scalability, transaction fail ratio scalability robustness, CPU consumption scalability, CPU consumption scalability robustness, RAM consumption scalability, RAM consumption scalability robustness, transaction fee scalability, transaction fee scalability robustness, security performance, and privacy performance of said blockchain technology solution.

2. The method according to claim 1, further comprising the step of: graphically displaying a result of the automatically determining step.

3. The method according to claim 1, further comprising the step of: automatically determining a transaction throughput scalability of said blockchain technology solution using said network of nodes operating at said network size and at said workload level.

4. The method according to claim 1, further comprising the step of: automatically determining a CPU consumption scalability of said blockchain technology solution using said network of nodes operating at said network size and at said workload level.

5. The method according to claim 1, further comprising the step of: automatically determining a transaction latency scalability of said blockchain technology solution using said network of nodes operating at said network size and at said workload level.

6. The method according to claim 1, further comprising the step of: automatically determining a transaction fee scalability of said blockchain technology solution using said network of nodes operating at said network size and at said workload level.

7. The method according to claim 1, further comprising the step of: automatically determining a security performance of said blockchain technology solution using said network of nodes operating at said network size and at said workload level.

8. A method of testing a blockchain technology solution, comprising the steps of:
selecting a network size;
selecting a workload level;
operating said blockchain technology solution using a network of nodes at said network size and with a workload at said workload level; and
automatically determining one or more of transaction latency workload, transaction latency workload robustness, transaction throughput workload, transaction throughput workload robustness, transaction fail ratio workload, transaction fail ratio workload robustness, CPU consumption workload, CPU consumption workload robustness, and RAM consumption workload, and RAM consumption workload robustness of said blockchain technology solution.

9. The method according to claim 8, further comprising the step of: graphically displaying a result of the automatically determining step.

10. The method according to claim 8, further comprising the step of: automatically determining a transaction latency workload of said blockchain technology solution using said network of nodes operating at said network size and at said workload level.

11. The method according to claim 8, further comprising the step of: automatically determining a transaction throughput workload of said blockchain technology solution using said network of nodes operating at said network size and at said workload level.

12. The method according to claim 8, further comprising the step of: automatically determining a transaction fail ratio workload of said blockchain technology solution using said network of nodes operating at said network size and at said workload level.

13. The method according to claim 8, further comprising the step of: automatically determining a CPU consumption workload of said blockchain technology solution using said network of nodes operating at said network size and at said workload level.

14. The method according to claim 8, further comprising the step of: automatically determining a CPU consumption workload robustness of said blockchain technology solution using said network of nodes operating at said network size and at said workload level.

15. The method according to claim 8, further comprising the step of: automatically determining a RAM consumption workload of said blockchain technology solution using said network of nodes operating at said network size and at said workload level.

16. A method of testing a blockchain technology solution, comprising the steps of:
selecting a network size;
selecting a workload level;
operating said blockchain technology solution using a network of nodes at said network size and with a workload at said workload level; and
automatically identifying a potential flaw in said blockchain technology solution operating at said network size and at said workload level.

17. The method according to claim 16, further comprising the step of: graphically displaying an identification of said potential flaw.

18. The method according to claim 16, further comprising the step of: automatically counting potential flaws in said blockchain technology solution operating at said network size and at said workload level.

19. The method according to claim 16, further comprising the step of: automatically evaluating a severity of a potential flaw in said blockchain technology solution operating at said network size and at said workload level.

20. The method according to claim 16, further comprising the step of: automatically measuring a privacy mechanism in said blockchain technology solution.
